(19) United States
(12) Patent Application Publication
(10) Pub. No.: US 2026/0030765 A1
(43) Pub. Date: Jan. 29, 2026

(54) METHOD FOR MEASURING MOTION POSTURES OF LOWER LIMBS OF AUTOMOBILE COLLISION DUMMY

(71) Applicants: CHINA AUTOMOTIVE TECHNOLOGY AND RESEARCH CENTER CO., LTD., Tianjin (CN); CATARC AUTOMOTIVE TEST CENTER (TIANJIN) CO., LTD., Tianjin (CN)

(72) Inventors: Haitao ZHU, Tianjin (CN); Weidong LIU, Tianjin (CN); Yongqiang WU, Tianjin (CN); Zhixin LIU, Tianjin (CN); Haoyu BAI, Tianjin (CN); Yuechen JI, Tianjin (CN); Tianyi HAO, Tianjin (CN); Bingxu DUAN, Tianjin (CN); Kai WANG, Tianjin (CN); Cancan LIU, Tianjin (CN); Bin ZHANG, Tianjin (CN); Xiaoying SUN, Tianjin (CN)

(73) Assignees: CHINA AUTOMOTIVE TECHNOLOGY AND RESEARCH CENTER CO., LTD., Tianjin (CN); CATARC AUTOMOTIVE TEST CENTER (TIANJIN) CO., LTD., Tianjin (CN)

(21) Appl. No.: 19/264,744

(22) Filed: Jul. 9, 2025

(30) Foreign Application Priority Data
Jul. 24, 2024 (CN) 202410995475.2

(51) Int. Cl. G06T 7/246; G06T 7/13; G06T 7/73; G09B 23/32

(52) U.S. Cl. CPC G06T 7/246; G06T 7/13; G06T 7/73; G09B 23/32; G06T 2207/20084; G06T 2207/20212; G06T 2207/30268

(57) ABSTRACT

A method for measuring motion postures of lower limbs of an automobile collision dummy continuously collects lower limb images of the automobile collision dummy during a collision in a real automobile collision test; identifies an edge contour in each lower limb image; samples a plurality of points from the edge contours for fitting to obtain a lateral thigh expression, a lower medial thigh expression, a lateral lower leg expression, and a lower medial leg expression respectively; determines various bone positions, various joint positions, and various bone angles of each lower limb; and associates the various bone positions, the various joint positions, and an included angle between two ends of each joint in the plurality of lower limb images in a chronological order to form a series of two-dimensional human rod-shaped model diagrams.

### CROSS-REFERENCE TO RELATED APPLICATIONS

This application claims priority to Chinese Patent Application No. 202410995475.2, filed on Jul. 24, 2024, the content of which is incorporated herein by reference in its entirety.

### TECHNICAL FIELD

The present application relates to the technical field of automobile collision test dummies, and in particular to a method for measuring motion postures of lower limbs of an automobile collision dummy.

### BACKGROUND

There is a need for a collision test on an automobile in testing safety performance of the automobile. In a real automobile test, the dummy, simulating a real person, sits on a seat of the automobile, and then data of the dummy is collected in the automobile collision test to simulate a value of an occupant's injury in the event of an accident. In these tests, motion measurement of lower limbs of the driver's dummy is particularly important, because it is directly related to a degree of an injury that a driver may suffer in the accident and assessment of the safety performance of the automobile. In the collision accident, a motion state of the driver's lower limbs and their suffering impact force directly affect a possibility and severity of the injury. Accurately measuring motions of the driver's lower limbs through a real automobile collision test can help a researcher analyze and assess driver's injury risks under different collision conditions, which optimizes a design on the automobile, such as a steering wheel, a pedal, and a seat. Therefore, the driver's living space is expanded, and injuries of the driver are reduced.

In the prior art, various skeleton connection points of the lower limbs of the dummy cannot be directly measured by skin occlusion of the dummy, which makes it difficult to assess the motions of the lower limbs of the dummy in the real automobile collision test. In view of this, the present application is specially proposed.

### SUMMARY

In order to solve the above technical problems, the present application provides a method for measuring motion postures of lower limbs of an automobile collision dummy. By capturing edge contours of the lower limbs of the dummy and tracking and calculating a position and an angle change of a skeleton connection point in real time, a two-dimensional dynamic model diagram of the lower limbs of the dummy during a collision can be obtained. This method is efficient and accurate, and overcomes the problem of difficulty in directly measuring the skeleton connection point due to skin occlusion of the dummy in the prior art. This innovative method improves a speed and accuracy of data collection, thereby more effectively assessing an injury that a driver may suffer in an accident, and ultimately forming an assessment system for an automobile collision test.

An embodiment of the present application provides a method for measuring motion postures of lower limbs of an automobile collision dummy, including:
continuously collecting lower limb images of the automobile collision dummy during a collision in a real automobile collision test;
identifying an edge contour in each lower limb image;
sampling a plurality of points from the edge contours for fitting to obtain a lateral thigh expression, a medial thigh expression, a lateral lower leg expression, and a lower medial leg expression respectively;
obtaining a thigh bone expression according to a positional relationship among a thigh bone, a lower leg bone and edge contours, the lateral thigh expression, and the medial thigh expression, and obtaining a lower leg bone expression according to the lateral lower leg expression and the lower medial leg expression; and
determining various bone positions, various joint positions, and various bone angles of each lower limb according to the thigh bone expression and the lower leg bone expression; and
associating the various bone positions, the various joint positions, and an included angle between two ends of each joint in the plurality of lower limb images in a chronological order to form a two-dimensional human rod-shaped model diagram which characterizes a motion state of each lower limb.

The embodiment of the present application has the following technical effects.

Firstly, by capturing the edge contours of the lower limbs of the dummy in real time and calculating the position and the angle change of the skeleton connection point, the motions of the driver's lower limbs during the collision can be measured more accurately. Such high-precision data collection helps to more accurately simulate and assess an actual injury that the occupant may suffer in the collision, thus providing reliable data support for improvement in automobile safety performance. Accurate lower limb motion data can help automobile manufacturers and designers identify and improve safety designs of the automobile, such as a seat structure, a seat belt system, and a dashboard layout. These improvements can provide better protection for the driver, so as to reduce a risk of the injury in the collision accident, and improve overall safety of the automobile.

Secondly, high efficiency of this method means that more collision test data can be collected within a shorter period of time, which will accelerate a research and development process of an automobile safety technology. Rapidly obtained data feedback can be used for design improvement in time to shorten a duration from design to market. A traditional collision test is often expensive, and the method of the present application is expected to reduce a number of the collision tests by improving efficiency and accuracy of data collection, thereby reducing a cost of research and development.

Lastly, in the present application, an expression is formed on the basis of the edge contours, and the positions and the angles of the bones are obtained according to the positional relationship between the contours and the bones as well as a geometric principle, which overcomes a problem that the skeleton connection point is difficult to measure directly due to skin occlusion of the dummy in the prior art.

### BRIEF DESCRIPTION OF THE DRAWINGS

To more clearly describe the technical solutions of the specific embodiments of the present application or in the prior art, the accompanying drawings required to describe the specific embodiments or the prior art are briefly described below. Apparently, the accompanying drawings described below are some embodiments of the present application. Those of ordinary skill in the art may further obtain other accompanying drawings based on these accompanying drawings without creative effort.

FIG. 1 is a flow chart of a method for measuring motion postures of lower limbs of an automobile collision dummy provided by an embodiment of the present application.

FIG. 2 is a schematic diagram of arrangement positions of cameras provided by an embodiment of the present application.

FIG. 3 is a structural diagram of a deep convolutional neural network provided by an embodiment of the present application.

FIG. 4 is a schematic diagram of an edge contour of a lower limb of an automobile collision dummy provided by an embodiment of the present application.

FIG. 5 is a two-dimensional human rod-shaped model diagram provided by an embodiment of the present application.

### DETAILED DESCRIPTION OF THE EMBODIMENTS

To make the objective, technical solutions and advantages of the present application clearer, the technical solutions of the present application will be clearly and completely described below. Apparently, the embodiments described are merely some embodiments rather than all embodiments of the present application. Based on the embodiments of the present application, all other embodiments obtained by those of ordinary skill in the art without creative efforts shall fall within the protection scope of the present application.

The embodiment of the present application provides a method for measuring motion postures of lower limbs of an automobile collision dummy in a real automobile collision test, and is mainly suitable for an application scenario where motions of the lower limbs of the automobile collision dummy in the real automobile collision test are monitored. The automobile collision dummy may be configured on a real automobile or in a separate driving compartment.

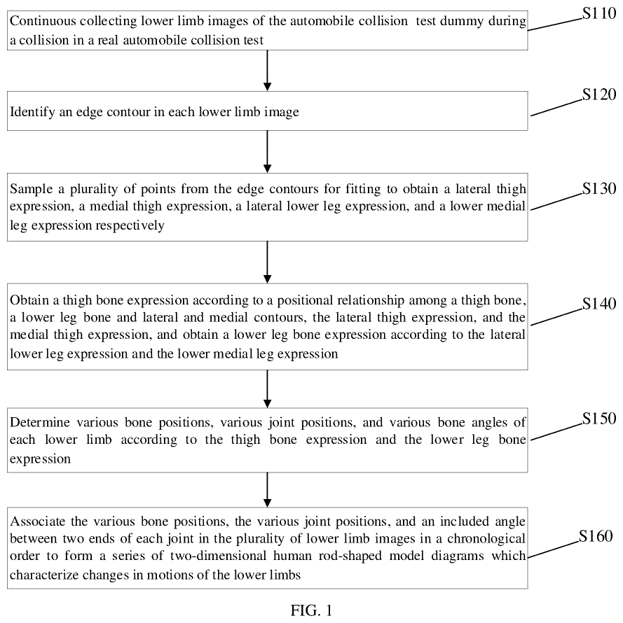

FIG. 1 is a flow chart of a method for measuring motion postures of lower limbs of an automobile collision dummy provided by an embodiment of the present application. Referring to FIG. 1, the method specifically includes:

S110: continuously collecting lower limb images of the automobile collision dummy during a collision in a real automobile collision test.

As the collision progresses, the lower limbs of the automobile collision dummy will move to a certain degree, which may be captured by cameras in a continuous photographing manner.

Optionally, in order to obtain a broader field of view and higher spatial resolution, a plurality of cameras are arranged in an automobile driving compartment in a lower limbs direction of the automobile collision dummy, and the lower limb images of the automobile collision dummy during the collision are continuously collected by the plurality of cameras at the same time.

Arrangement positions of the cameras are shown in FIG. 2, with 6 cameras being D₁, D₂, D₃, D₄, D₅, and D₆ respectively. A short focal length camera is preferred in order to obtain the wider field of view and the higher spatial resolution, so that subtle limb motions can be captured at the moment of collision. By precisely calibrating these cameras, it is ensured that the photographed images can overlap to form a continuous field of view, thereby covering all key areas of the lower limbs of the dummy. During the collision test, the plurality of cameras will work at the same time to capture contours of the dummy's lower limbs from different angles and different positions.

stitching the lower limb images collected by the plurality of cameras at a same time to form an image showing a complete lower limb. For example, in a case that there shows a lower leg in one image and a thigh in the other image, the images are stitched to show a complete lower limb. An image stitching technology is to stitch several images with overlapping parts into one seamless panoramic lower limb image, in which an image registration technology and an image fusion technology are applied. See the description of prior art for detail, here no longer repeat.

S120: identifying an edge contour in each lower limb image.

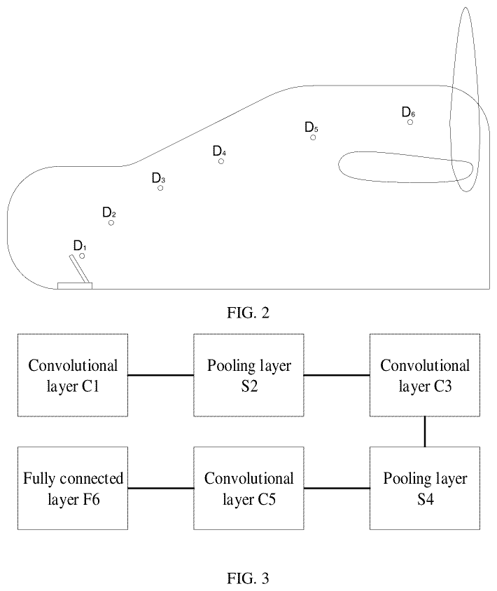

inputting each lower limb image into a deep convolutional neural network, and outputting positions of the edge contours of the thigh and the lower leg. FIG. 3 is a structural diagram of a deep convolutional neural network provided by an embodiment of the present application. Cᵢ is defined as a convolutional layer; Sᵢ represents a sub-sampling layer; and i represents a layer number. In FIGS. 3, C₁, C₃, and C₅ represent three convolutional layers; S₂ and S₄ represent two pooling layers; F₆ represents a fully connected layer; and an output layer outputs final image recognition results: positions of thigh and lower leg edge contours.

The following will introduce mathematical formulas of the convolutional layers and the pooling layers. In one convolutional layer, each feature pixel value in a feature map is formed by a convolution kernel of this layer and an output image of its previous layer by means of sliding convolution. Therefore, the calculation formula for the feature pixel value

$${y}_{pj}^{( l )}$$

can be expressed as:

$${y}_{pj}^{( l )} = f [ {\sum }_{i ∈ {M}_{j}^{( j - 1 )}} {\sum }_{( u , v ) ∈ {K}^{( l )}} {W}_{ij ( u , v )}^{( l )} \cdot {X}_{pi}^{( l - 1 )} ( {c}^{′} + u , r + v ) + {b}_{j}^{( l )} ] ; \qquad ( 1 )$$

where K={(u, v)∈N²|0≤u≤kₓ; 0≤v≤k_{y}}, kₓ and k_{y} represent a length and a width of a convolution kernel

$${W}_{ij}^{( l )}$$

of layer l respectively.

$${b}_{j}^{( l )}$$

is a bias of a corresponding j^{th} feature map of layer l. Variables c′ and r represent current longitudinal and lateral feature pixels respectively; and variables u and v represent longitudinal and lateral step sizes of the convolution kernel

$${W}_{ij}^{( l )}$$

respectively. p represents a corresponding p^{th} training sample. A symbol f represents an activation function of layer l. A convolution operation occurs when the convolution kernel is convolved with the input feature map

$${X}_{pi}^{( l - 1 )} ;$$

1 represents the layer number of the convolutional layer; i represents which feature pixel; and

$${M}_{j}^{( j - 1 )}$$

represents the feature pixel in the j^{th} feature map.

In one pooling layer, each pixel value of a feature map is sampled by a pooling window sliding over a convolution feature map output by the previous layer. The pooling layer used here is an average pooling layer, and the calculation formula for the pooled feature pixel value

$$y\_ {1}_{pj}^{( l )}$$

may be expressed as:

$$y\_ {1}_{pj}^{( l )} = ( \frac{{\sum }_{( u , v ) ∈ {S}^{( l )}} {X}_{pi}^{( l - 1 )} ( {c}^{′} + {u}^{′} , r + {v}^{′} )}{( {S}_{x} \cdot {S}_{y} )} ) ; \qquad ( 2 )$$

$$where {S}^{( l )} = \{ ( i , j ) ∈ {N}^{2} \vert 0 \leq u \leq {s}_{x}^{( l )} , 0 \leq v \leq {s}_{y}^{( l )} \} , {s}_{x}^{( l )} , and {s}_{y}^{( l )}$$

are defined as sub-sampling layers of layer l respectively. Variables c′ and r represent current longitudinal and lateral feature pixels respectively; and variables u′ and v′ represent longitudinal and lateral step sizes of the pooling window respectively. An average pooling operation is to add all the feature pixel values in the pooling window, and then divide a sum by a total number of pixels in the pooling window to obtain an average value of a pooling area.

The formula for the feature pixel value

$$y\_ {2}_{pj}^{( l )}$$

calculated by the fully connected layer may be expressed as:

$$y\_ {2}_{pj}^{( l )} = f ( {\sum }_{i = 0}^{{N}^{( l - 1 )}} X\_ {1}_{pi}^{( l - 1 )} \cdot W\_ {1}_{ji}^{( l )} + b\_ {1}_{j}^{( l )} ) ; \qquad ( 3 )$$

where N^{(l-1)} represents a number of neurons in layer l−1.

$$W\_ {1}_{ji}^{( l )}$$

is a weight that connects neuron i in layer l−1 to neuron j in layer j.

$$b\_ {1}_{j}^{( l )}$$

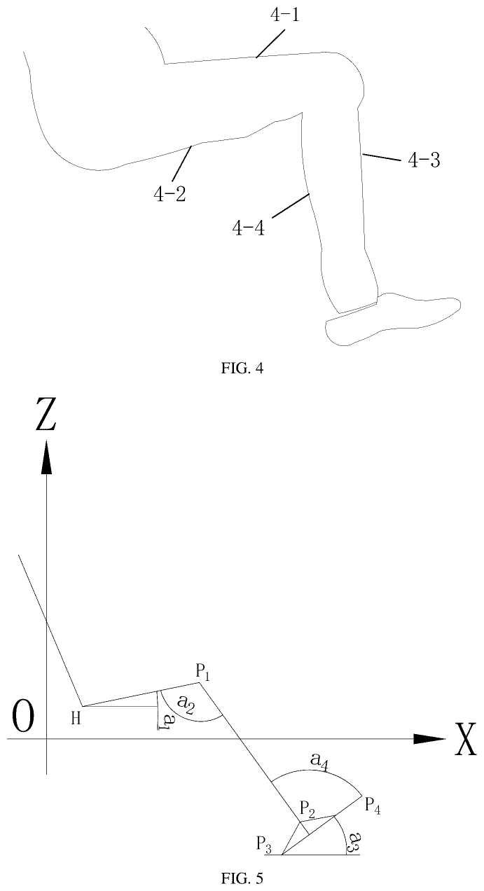

is a bias or j^{th} neuron in layer l; and f is an activation function of layer l. The classical sigmoid function is used here as an output function of an output neuron. After feature extraction of the entire convolutional neural network, an original image finally becomes a feature vector of an output layer of the fully connected layer. These feature vectors are finally sent to a classifier for classification, and deep edge features of the entire network can be extracted, to obtain edge contours of lateral thigh 4-1, medial thigh 4-2, lateral lower leg 4-3, and lower medial leg 4-4 shown in FIG. 4.

S130: sampling a plurality of points from the edge contours for fitting to obtain a lateral thigh expression, a medial thigh expression, a lateral lower leg expression, and a lower medial leg expression respectively.

It can be seen from FIG. 4 that the contours of lateral thigh 4-1, medial thigh 4-2, lateral lower leg 4-3, and lower medial leg 4-4 have their own characteristics and are suitable for separate expression establishment.

Optionally, a plurality of points are sampled from the edge contours of a lateral thigh, a medial thigh, a lateral lower leg, and a medial lower leg at an equal interval for first degree polynomial curve fitting, to obtain expressions for corresponding parts.

Referring to FIG. 5, an x-z rectangular coordinate system is established with an intersection of a seat back and a seat cushion as an origin, with an x-axis in a cushion direction and a z-axis in a back direction. Coordinates (x, z) of each point on each edge contour line, processed by the deep convolutional neural network, of each dummy's lower limb may be obtained. A coordinate is taken for each point on the edge line every 1 mm, and denoted as (xᵢ, zᵢ); i=1, 2, . . . , n, where x is a sequence of natural numbers ranging from 1 to n. First degree polynomial curve fitting is performed on various edge contours according to the coordinates of various points, to obtain a function expression.

The mathematical formula for a first degree polynomial curve fitting operation is as follows. Given the coordinates of various points as (xᵢ, zᵢ), let the first degree polynomial curve fitting function \hat{z} of these data be:

$$\hat{z} = {a}_{0} x + {a}_{1} ; \qquad ( 4 )$$

where a₀ and a₁ are coefficients to be fitted.

According to a least squares polynomial fitting principle, the fitting formula may be obtained as follows:

$$\{ \begin{matrix}{a}_{0} \cdot {\sum }_{i = 1}^{n} {x}_{i} + {a}_{1} \cdot n = {\sum }_{i = 1}^{n} {z}_{i} \\ {a}_{0} \cdot {\sum }_{i = 1}^{n} {x}_{i}^{2} + {a}_{1} \cdot {\sum }_{i = 1}^{n} {x}_{i} = {\sum }_{i = 1}^{n} {x}_{i} \cdot {z}_{i}\end{matrix} ; \qquad ( 5 )$$

In the formula (5), let

$${\sum }_{i = 1}^{n} {x}_{i} = b , {\sum }_{i = 1}^{n} {z}_{i} = c , {\sum }_{i = 1}^{n} {x}_{i}^{2} = d , and {\sum }_{i = 1}^{n} {x}_{i} \cdot {z}_{i} = e ,$$

the formula may be expressed as:

$$\{ \begin{matrix}{a}_{0} \cdot {\sum }_{i = 1}^{n} {x}_{i} + {a}_{1} \cdot n = {\sum }_{i = 1}^{n} {z}_{i} \\ {a}_{0} \cdot {\sum }_{i = 1}^{n} {x}_{i}^{2} + {a}_{1} \cdot {\sum }_{i = 1}^{n} {x}_{i} = {\sum }_{i = 1}^{n} {x}_{i} \cdot {z}_{i}\end{matrix} ; \qquad ( 5 )$$

is a cumulative sum of natural numbers. Let n start from 1, it may be obtained according to a summation formula of arithmetic sequence as follows:

$${\sum }_{i = 1}^{n} {x}_{i} = b = \frac{n \cdot ( n + 1 )}{2} ; \qquad ( 7 )$$

It can be obtained from a formula of sum of squares of arithmetic sequence:

$${\sum }_{i = 1}^{n} {x}_{i}^{2} = d = \frac{n \cdot ( n + 1 ) \cdot ( 2 n + 1 )}{6} = \frac{b \cdot ( 2 n + 1 )}{3} ; \qquad ( 8 )$$

First, substituting the formula (8) and the formula (7) into the formula (5) may obtain:

$${a}_{0} = \frac{n \cdot e - b \cdot c}{n \cdot d - b \cdot b} = \frac{n \cdot e - \frac{n \cdot ( n + 1 )}{2} \cdot c}{n \cdot \frac{n \cdot ( n + 1 ) \cdot ( 2 n + 1 )}{6} - \frac{n \cdot ( n + 1 )}{2} \cdot \frac{n \cdot ( n + 1 )}{2}} ; \qquad ( 9 )$$

In order to reduce calculation, (n+1) in a numerator and denominator may be reduced to obtain the optimal calculation formula for the coefficient a₀:

$${a}_{0} = \frac{e - \frac{n + 1}{2} \cdot c}{\frac{n \cdot ( n + 1 ) \cdot ( n - 1 )}{12}} = \frac{6 \cdot ( 2 \frac{e}{n + 1} - c )}{n \cdot ( n - 1 )} ; \qquad ( 10 )$$

$$where {\sum }_{i = 1}^{n} {x}_{i} \cdot {z}_{i} = e$$

is a form of multiplying before integration, usually obtaining a large value, so the best is to perform calculation of

$$\frac{e}{n + 1}$$

first in calculation, and then multiply an answer by 2. In this way, shift can be used for fast calculation.

After the expression for a₀ is obtained, the formula (10) is substituted into the formula (6), and the calculation formula for the coefficient a₁ is obtained:

$${a}_{1} = \frac{c - {a}_{0} \cdot b}{n} = \frac{c \frac{{a}_{0} \cdot n ( n + 1 )}{2}}{n} = \frac{c}{n} - \frac{{a}_{0} \cdot ( n + 1 )}{2} ; \qquad ( 11 )$$

At this point, both the calculation formulas for two coefficients in the fitting formula have been obtained. Similarly, the coefficients of fitting functions for other edge lines may be obtained. Assuming that by using the method, it is obtained that the lateral thigh expression of the dummy is z₁=a₀x+a₁, the medial thigh expression of the dummy is z₂=a₂x+a₃, the lateral lower leg expression of the dummy is z₃=a₄x+a₅, and the lower medial leg expression of the dummy is z₄=a₆x+a₇.

S140: obtaining a thigh bone expression according to a positional relationship among a thigh bone, a lower leg bone and lateral and medial contours, the lateral thigh expression, and the medial thigh expression, and obtaining a lower leg bone expression according to the lateral lower leg expression and the lower medial leg expression.

The lateral and medial contours form the thigh edge contour corresponding to the thigh bone (including a lateral thigh contour and a medial thigh contour), or the lower leg edge contour corresponding to the lower leg bone (including a lateral lower leg contour and a medial lower leg contour).

Specifically, step S140 may further be stated as follows: obtaining the thigh bone expression according to the positional relationship among the thigh bone, the thigh edge contour, the lateral thigh expression, and the medial thigh expression, and obtaining the lower leg bone expression according to a positional relationship between the lower leg bone and the lower leg edge contour, the lateral lower leg expression, and the lower medial leg expression.

In the automobile collision dummy, the thigh bone and the lower leg bone are in set positions of a leg. Therefore, in order to simplify calculation, the thigh bone and the lower leg bone are simplified as lines, and the expressions for the thigh bone and the lower leg bone may be determined according to the positional relationships among the thigh bone, the lower leg bone and the lateral and medial contours.

Specifically, the thigh bone and lower leg bone of the dummy are located in a center of upper and lower edges, that is, the thigh bone is located in a center of the lateral thigh contour and the medial thigh contour, and the lower leg bone is located in a center of the later lower leg contour and the lower medial leg contour. Therefore, an average of the lateral thigh expression and the medial thigh expression is used as the thigh bone expression, and an average of the lateral lower leg expression and the lower medial leg expression is used as the lower leg bone expression. Based on the above, the thigh bone expression of the dummy may be obtained as:

$${Z}_{1} = \frac{{z}_{1} + {z}_{2}}{2} = \frac{{a}_{0} + {a}_{2}}{2} x + \frac{{a}_{1} + {a}_{3}}{2} ; \qquad ( 12 )$$

Similarly, the lower leg bone expression of the dummy may be obtained as:

$${Z}_{2} = \frac{{z}_{3} + {z}_{4}}{2} = \frac{{a}_{4} + {a}_{6}}{2} x + \frac{{a}_{5} + {a}_{7}}{2} ; \qquad ( 13 )$$

Referring to FIG. 5, the thigh bone expression is an expression for line segment HP₁, and the lower leg bone expression is an expression for line segment HP₂.

S150: determining various bone positions, various joint positions, and various bone angles of each lower limb according to the thigh bone expression and the lower leg bone expression.

Referring to FIG. 5, various joints include point P₁ of a knee joint, point P₂ of an ankle joint and point H (a connection point between a human torso and the thigh); and the lower limb bones include the thigh bone (i.e., line segment HP₁) and the lower leg bone (i.e., line segment P₁P₂). Various bone angles include an included angle α₁ between the thigh bone and the horizontal plane, an included angle α₃+α₄ between the lower leg bone and the horizontal plane, and an included angle α₂ between the thigh bone and the lower leg bone.

Specifically, the thigh bone expression (12) and the lower leg bone expression (13) are combined to obtain a position of a knee joint, i.e. a coordinate of the connection point P₁ (i.e. the knee joint) between the thigh bone and the lower leg bone.

$$\{ \begin{matrix}{x}_{{P}_{1}} = \frac{( {a}_{5} + {a}_{7} - {a}_{1} - {a}_{3} )}{( {a}_{0} + {a}_{2} - {a}_{4} - {a}_{6} )} \\ {z}_{{P}_{1}} = \frac{( {a}_{0} + {a}_{2} ) \cdot \frac{( {a}_{5} + {a}_{7} - {a}_{1} - {a}_{3} )}{( {a}_{0} + {a}_{2} - {a}_{4} - {a}_{6} )} + ( {a}_{1} + {a}_{3} )}{2}\end{matrix} ; \qquad ( l4 )$$

According to a length L₁ of the thigh bone (i.e. a length of line segment HP₁) and a coordinate of point P₁ of the knee joint, a position of point H of the automobile collision dummy is obtained, that is, a coordinate of point H is obtained by combining the formula (12) and the formula (14):

$$\{ \begin{matrix}{x}_{H} = \frac{( {a}_{5} + {a}_{7} - {a}_{1} - {a}_{3} )}{( {a}_{0} + {a}_{2} - {a}_{4} - {a}_{6} )} - {L}_{1} \cdot \sqrt{\frac{{( {a}_{0} + {a}_{2} )}^{2} + 4}{4}} \\ {z}_{H} = \frac{( {a}_{0} + {a}_{2} ) \cdot \frac{( {a}_{5} + {a}_{7} - {a}_{1} - {a}_{3} )}{( {a}_{0} + {a}_{2} - {a}_{4} - {a}_{6} )} + ( {a}_{1} + {a}_{3} )}{2} - {L}_{1} \cdot \frac{( {a}_{0} + {a}_{2} )}{2} \cdot \sqrt{\frac{{( {a}_{0} + {a}_{2} )}^{2} + 4}{4}}\end{matrix} ; \qquad ( 15 )$$

According to a length L₂ of the lower leg bone (i.e. a length of line segment P₁P₂), a coordinate of point P₁ of the knee joint and the lower leg bone expression, a coordinate of point P₂ of the ankle joint is obtained, that is, it can be obtained by combining the formula (13) and the formula (14) that a coordinate of a connection point P₂ between the lower leg bone and a foot is:

$$\{ \begin{matrix}{x}_{{P}_{2}} = \frac{( {a}_{5} + {a}_{7} - {a}_{1} - {a}_{3} )}{( {a}_{0} + {a}_{2} - {a}_{4} - {a}_{6} )} + {L}_{2} \cdot \sqrt{\frac{{( {a}_{4} + {a}_{6} )}^{2} + 4}{4}} \\ {z}_{{P}_{2}} = \frac{( {a}_{0} + {a}_{2} ) \cdot \frac{( {a}_{5} + {a}_{7} - {a}_{1} - {a}_{3} )}{( {a}_{0} + {a}_{2} - {a}_{4} - {a}_{6} )} + ( {a}_{1} + {a}_{3} )}{2} - {L}_{2} \cdot \frac{( {a}_{4} + {a}_{6} )}{2} \cdot \sqrt{\frac{{( {a}_{4} + {a}_{6} )}^{2} + 4}{4}}\end{matrix} ; \qquad ( 16 )$$

According to the thigh bone expression, the lower leg bone expression, and the position of the knee joint, an included angle α₁ between the thigh bone and a horizontal plane as well as an included angle α₂ between the thigh bone and the lower leg bone are obtained, that is, it can be obtained by combining the formula (12), the formula (13) and the formula (14) that the included angle α₁ between the thigh bone and a horizontal plane as well as the included angle α₂ between the thigh bone and the lower leg bone respectively are:

$$\{ \begin{matrix}{α}_{1} = arc tan {k}_{1} = arc tan ( \frac{( {a}_{0} + {a}_{2} )}{2} ) \\ {α}_{2} = arc tan ( \frac{{k}_{2} - {k}_{1}}{1 + {k}_{1} \cdot {k}_{2}} ) = arc tan ( \frac{2 \cdot ( {a}_{4} + {a}_{6} - {a}_{0} - {a}_{2} )}{4 + ( {a}_{0} + {a}_{2} ) \cdot ( {a}_{4} + {a}_{6} )} )\end{matrix} ; \qquad ( 17 )$$

In addition to calculating the positions and the angles of the thigh and the lower leg, the embodiment also considers a position and an angle of the dummy's shoe, so as to study a motion state of the dummy's lower limb more comprehensively.

Specifically, the identifying an edge contour in each lower limb image includes: inputting each lower limb image into the deep convolutional neural network, and outputting a position of an edge contour of the shoe. The deep convolutional neural network has the characteristics of extracting an edge contour of an object, and can extract the edge contours of the thigh, the lower leg and the shoe by means of image processing. On this basis, the shoe is simplified as straight line segment P₃P₄ to determine a length and an angle of the shoe.

Referring to FIG. 5, positions of two endpoints in a length direction (that is, in a length direction of the shoe) is identified from the shoe contour of each lower limb image; and the two endpoints include a lower edge point P₃(x_{P}_{₃}, z_{P}_{₃}) and an upper edge point P₄(x_{P}_{₄}, z_{P}_{₄}). A shoe expression is constructed according to the positions of two endpoints as follows:

$${Z}_{3} = ( \frac{{z}_{{P}_{4}} - {z}_{{P}_{3}}}{{x}_{{P}_{4}} - {x}_{{P}_{3}}} ) \cdot x + {z}_{{P}_{3}} - ( \frac{{z}_{{P}_{4}} - {z}_{{P}_{3}}}{{x}_{{P}_{4}} - {x}_{{P}_{3}}} ) \cdot {x}_{{P}_{3}} ; \qquad ( 18 )$$

The shoe expression (18) and the lower leg bone expression (13) are combined to obtain an included angle α₃ between the shoe and the horizontal plane as well as an included angle α₄ between the shoe and the lower leg:

$$\{ \begin{matrix}{α}_{3} = arc tan {k}_{3} = arctan ( \frac{{z}_{{P}_{4}} - {z}_{{P}_{3}}}{{x}_{{P}_{4}} - {x}_{{P}_{3}}} ) \\ {α}_{4} = arctan ( \frac{{k}_{2} - {k}_{3}}{1 + {k}_{2} \cdot {k}_{3}} ) = arctan ( \frac{( \frac{{a}_{4} + {a}_{6}}{2} ) - ( \frac{{z}_{{P}_{4}} - {z}_{{P}_{3}}}{{x}_{{P}_{4}} - {x}_{{P}_{3}}} )}{1 + ( ( \frac{{a}_{4} + {a}_{6}}{2} ) \cdot ( \frac{{z}_{{P}_{4}} - {z}_{{P}_{3}}}{{x}_{{P}_{4}} - {x}_{{P}_{3}}} ) )} )\end{matrix} ; \qquad ( 19 )$$

S160: associating the various bone positions, the various joint positions, and an included angle between two ends of each joint in the plurality of lower limb images in a chronological order to form a series of two-dimensional human rod-shaped model diagrams which characterize changes in motions of the lower limbs.

Finally, the coordinates and the angles of various lower limb bones and various joints of the dummy are calculated to form a two-dimensional human rod model, as shown in FIG. 5. In the real automobile colliding the dummy, various cameras capture motions in real time. Through the above analysis, the series of two-dimensional human rod-shaped model diagrams are obtained, that is, the motions of the key points of the lower limbs of the dummy in the real automobile collision are known.

It should be noted that the terms used in the present application are merely for describing specific embodiments, rather than limiting the scope of the present application. As shown in the specification of the present application, unless the context clearly suggests an exception, the words such as “a”, “an”, “one” and/or “the” do not refer to the singular, or may include the plural. The terms “include”, “comprise”, or any variants thereof are intended to cover a non-exclusive inclusion, so that a process, method, article, or device that includes a series of elements not only includes those elements, but also includes other elements not listed explicitly, or includes inherent elements of the process, method or device. In the absence of more limitations, an element defined by “include a . . . ” does not exclude other same elements existing in the process, method or device including the element.

It should be further noted that orientations or positional relationships indicated by terms, such as “center”, “upper”, “lower”, “left”, “right”, “vertical”, “horizontal”, “inner” and “outer” are based on orientations or positional relationships shown in the drawings, are to facilitate the description of the present application and simplify the description merely, do not indicate or imply that the referred apparatuses or elements must have specific orientations and are constructed and operated in the specific orientations and thus should not be construed to limit the present application. Unless otherwise clearly specified and defined, the terms “mount”, “interconnect” and “connect” should be understood in their broad sense. For example, the terms may be “fixedly connect”, “detachably connect” or “integrally connect”; “mechanically connect” and “electrically connect”; or “directly interconnect”, “indirectly interconnect through an intermediate” or “the communication between the interiors of two elements”. The terms described above have specific meanings in the present application that can be understood by those of ordinary skills in the art in light of the particular circumstances.

Finally, it should be noted that: the above embodiments are merely used for illustrating the technical solutions of the present application, but do not limit them; although the present application has been described in detail with reference to the foregoing embodiments, those of ordinary skills in the art should understand that: the technical solutions recorded in the foregoing embodiments may still be modified, or some or all of the technical features therein may be equivalently substituted; however, these modifications or substitutions do not separate the essence of the corresponding technical solutions from the technical solutions of the embodiments of the present application.

1. A method for measuring motion postures of lower limbs of an automobile collision dummy, comprising:
continuously collecting lower limb images of the automobile collision dummy during a collision in a real automobile collision test;
identifying an edge contour in each lower limb image;
sampling a plurality of points from the edge contours of lateral thighs, lower medial thighs, lateral lower legs, and lower medial legs at an equal interval for first degree polynomial curve fitting, to obtain a lateral thigh expression, a medial thigh expression, a lateral lower leg expression, and a lower medial leg expression respectively;
obtaining a thigh bone expression according to a positional relationship among a thigh bone and lateral and medial contours, the lateral thigh expression, and the medial thigh expression, and obtaining a lower leg bone expression according to a positional relationship among a lower leg bone and lateral and medial contours, the lateral lower leg expression and the lower medial leg expression, wherein the thigh bone and the lower leg bone are simplified as lines, and expressions for the thigh bone and the lower leg bone are determined according to the positional relationship among the thigh bone, the lower leg bone and the lateral and medial contours, the thigh bone and the lower leg bone of the dummy are located in centers of upper and lower edges, the lateral thigh expression and the medial thigh expression are averaged as the thigh bone expression, and the lateral lower leg expression and the lower medial leg expression are averaged as the lower leg bone expression;
determining various bone positions, various joint positions, and various bone angles of each lower limb according to the thigh bone expression and the lower leg bone expression; and
associating the various bone positions, the various joint positions, and an included angle between two ends of each joint in the plurality of lower limb images in a chronological order to form a series of two-dimensional human rod-shaped model diagrams which characterize changes in motions of the lower limbs.

2. The method according to claim 1, wherein a plurality of cameras are arranged in an automobile driving compartment in a lower limbs direction of the automobile collision dummy:
the continuously collecting lower limb images of the automobile collision dummy during a collision in a real automobile collision test comprises:
continuously collecting lower limb images of the automobile collision dummy by the plurality of cameras during a collision in a real automobile collision test; and
stitching the lower limb images collected by the plurality of cameras at a same time to form an image showing a complete lower limb.

3. The method according to claim 1, wherein the identifying an edge contour in each lower limb image comprises:
inputting each lower limb image into a deep convolutional neural network, and outputting positions of the edge contours of the thigh and the lower leg.

4. The method according to claim 3, wherein the determining various bone positions, various joint positions, and various bone angles of each lower limb according to the thigh bone expression and the lower leg bone expression comprises:
combining the thigh bone expression and the lower leg bone expression to obtain a position of a knee joint;
obtaining a position of point H of the automobile collision dummy according to a length of the thigh bone and the position of the knee joint;
obtaining a position of an ankle joint according to the length of the lower leg bone, the position of the knee joint, and the lower leg bone expression; and
obtaining an included angle between the thigh bone and a horizontal plane as well as an included angle between the thigh bone and the lower leg bone according to the thigh bone expression, the lower leg bone expression, and the position of the knee joint.

5. The method according to claim 1, wherein the identifying an edge contour in each lower limb image comprises:
inputting each lower limb image into a deep convolutional neural network, and outputting a position of an edge contour of a shoe.

6. The method according to claim 5, wherein the determining various bone positions, various joint positions, and various bone angles of each lower limb according to the thigh bone expression and the lower leg bone expression comprises:
identifying positions of two endpoints in a length direction from a shoe contour of each lower limb image;
constructing a shoe expression according to the positions of two endpoints; and
combining the shoe expression and the lower leg bone expression to obtain an included angle between the shoe and the horizontal plane as well as an included angle between the shoe and the lower leg.
